(19) United States
(12) Patent Application Publication
(10) Pub. No.: US 2026/0024286 A1
(43) Pub. Date: Jan. 22, 2026

(54) SYSTEMS AND METHODS FOR PROVIDING INTELLIGENT EMBODIED INTERACTIVE AGENTS WITH SPATIAL UNDERSTANDING

(71) Applicant: JPMORGAN CHASE BANK, N.A., New York, NY (US)

(72) Inventors: Pranav DESHPANDE, Jersey City, NJ (US); Mengyu CHEN, Los Angeles, CA (US); Elvir AZANLI, Union, NJ (US); Monica LANDER, New York, NY (US); Kristine W MA, Cupertino, CA (US); Joseph W LIGMAN, Weston, CT (US); Marco PISTOIA, Amawalk, NY (US)

(21) Appl. No.: 18/778,292

(22) Filed: Jul. 19, 2024

(51) Int. Cl. G06T 19/00; G06T 13/40

(52) U.S. Cl. CPC G06T 19/006; G06T 13/40

(57) ABSTRACT

A method may include: a conversational artificial intelligence engine receiving from an augmented reality headset worn by a user, a query including audio and images/video that is made to an embodied interactive agent that is displayed in a display of the augmented reality headset; the conversational artificial intelligence engine generating a prompt for a large language model based on the user utterance and the images or video; the conversational artificial intelligence engine providing the prompt to the large language model; the conversational artificial intelligence engine receiving an output of the large language model, wherein the output comprises text and gestures for the embodied interactive agent; the conversational artificial intelligence engine generating animations for the embodied interactive agent from the gestures and speech for the embodied interactive agent based on the text; and the conversational artificial intelligence engine outputting the animations and the speech to the augmented reality headset.

### BACKGROUND OF THE INVENTION

### 1. Field of the Invention

Embodiments relate to systems and methods for providing intelligent embodied interactive agents with spatial understanding.

### 2. Description of the Related Art

The introduction of mixed reality devices and headsets has led to the creation of a new paradigm of computing-spatial computing. Spatial computing offers the user with an opportunity to interact with the environment and the computer in various ways. There is, however, a lack of interactive agents with spatial understanding in the mixed reality and spatial computing space.

### SUMMARY OF THE INVENTION

Systems and methods for providing intelligent embodied interactive agents with spatial understanding are disclosed. According to one embodiment, a method may include: (1) receiving, by a conversational artificial intelligence engine and from an augmented reality headset worn by a user, a query that is made to an embodied interactive agent that is displayed in a display of the augmented reality headset, wherein the query may include audio of a user utterance and images or video captured by a camera of the augmented reality headset of what the user is seeing; (2) generating, by the conversational artificial intelligence engine, a prompt for a large language model based on the user utterance and the images or video; (3) providing, by the conversational artificial intelligence engine, the prompt to the large language model; (4) receiving, by the conversational artificial intelligence engine, an output of the large language model, wherein the output may include text and gestures for the embodied interactive agent; (5) generating, by the conversational artificial intelligence engine, animations for the embodied interactive agent from the gestures and speech for the embodied interactive agent based on the text; and (6) outputting, by the conversational artificial intelligence engine, the animations and the speech to the augmented reality headset.

In one embodiment, the method may also include receiving, by the conversational artificial intelligence engine, user location information from the augmented reality headset, wherein the prompt may be further based on the user location information.

In one embodiment, the method may also include inferring, by the conversational artificial intelligence engine, a task goal associated with the query, wherein the inference may be based on a user interaction history, environment object labels, and user location information.

In one embodiment, the conversational artificial intelligence engine generates a text prompt for the large language model based on the user utterance and an image prompt for a visual language model, and the large language model and the visual language model return outputs.

In one embodiment, the large language model may include a multi-modal large language model.

In one embodiment, the large language model further outputs an identification of a document to provide to the augmented reality headset.

In one embodiment, the display in the augmented reality headset displays the animations for the embodied interactive agent, and a speaker in the augmented reality headset outputs the speech for the embodied interactive agent.

According to another embodiment, a system may include: an augmented reality headset comprising a camera, a microphone, a display, and a speaker, wherein the augmented reality headset may be configured to be worn by a user; and a multi-modal conversational platform comprising a conversational artificial intelligence engine that may be configured to receive, from the augmented reality headset, a query that is made to an embodied interactive agent that is displayed by the display, wherein the query may include audio of a user utterance and images or video captured by the camera of what the user is seeing; to generate a prompt for a large language model based on the user utterance and the images or video; to provide the prompt to the large language model, to receive an output of the large language model, wherein the output may include text and gestures for the embodied interactive agent, to generate animations for the embodied interactive agent from the gestures and speech for the embodied interactive agent based on the text; and to output the animations and the speech to the augmented reality headset. The display of the augmented reality headset is configured to display the animations of the embodied interactive agent, and the speaker is configured to output the speech of the embodied interactive agent.

In one embodiment, the conversational artificial intelligence engine may be further configured to receive user location information from the augmented reality headset, and the prompt may be further based on the user location information.

In one embodiment, the conversational artificial intelligence engine may be further configured to infer a task goal associated with the query, wherein the inference may be based on a user interaction history, environment object labels, and user location information.

In one embodiment, the conversational artificial intelligence engine may be further configured to generate a text prompt for the large language model based on the user utterance, and an image prompt for a visual language model, and the large language model and the visual language model return outputs.

In one embodiment, the large language model may include a multi-modal large language model.

In one embodiment, the large language model further outputs an identification of a document to provide to the augmented reality headset.

According to another embodiment, a non-transitory computer readable storage medium may include instructions stored thereon, which when read and executed by one or more computer processors, cause the one or more computer processors to perform steps comprising: receiving, from an augmented reality headset worn by a user, a query that is made to an embodied interactive agent that is displayed in a display of the augmented reality headset, wherein the query may include audio of a user utterance and images or video captured by a camera of the augmented reality headset of what the user is seeing; generating a prompt for a large language model based on the user utterance and the images or video; providing the prompt to the large language model; receiving an output of the large language model, wherein the output may include text and gestures for the embodied interactive agent; generating animations for the embodied interactive agent from the gestures and speech for the embodied interactive agent based on the text; and outputting the animations and the speech to the augmented reality headset.

In one embodiment, the non-transitory computer readable storage medium may also include instructions stored thereon, which when read and executed by the one or more computer processors, cause the one or more computer processors to perform steps comprising: receiving user location information from the augmented reality headset, wherein the prompt may be further based on the user location information.

In one embodiment, the non-transitory computer readable storage medium may also include instructions stored thereon, which when read and executed by the one or more computer processors, cause the one or more computer processors to perform steps comprising: inferring a task goal associated with the query, wherein the inference may be based on a user interaction history, environment object labels, and user location information.

In one embodiment, the non-transitory computer readable storage medium may also include instructions stored thereon, which when read and executed by the one or more computer processors, cause the one or more computer processors to perform steps comprising: generating, a text prompt for the large language model based on the user utterance and an image prompt for a visual language model, and receiving outputs from the large language model and the visual language model.

In one embodiment, the large language model may include a multi-modal large language model.

In one embodiment, the non-transitory computer readable storage medium may also include instructions stored thereon, which when read and executed by the one or more computer processors, cause the one or more computer processors to perform steps comprising: receiving from the large language model further, an identification of a document to provide to the augmented reality headset.

In one embodiment, the display in the augmented reality headset displays the animations for the embodied interactive agent, and a speaker in the augmented reality headset outputs the speech for the embodied interactive agent.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for providing intelligent embodied interactive agents with spatial understanding according to an embodiment;

FIG. 2 illustrates an exemplary architecture for a conversational AI engine according to an embodiment;

FIG. 3 illustrates an exemplary architecture for a conversational AI engine according to another embodiment;

FIG. 4 illustrates an exemplary architecture for a conversational AI engine according to another embodiment;

FIG. 5 illustrates a system for providing intelligent embodied interactive agents with spatial understanding according to an embodiment; and

FIG. 6 depicts an exemplary computing system for implementing aspects of the present disclosure.

### DETAILED DESCRIPTION OF PREFERRED EMBODIMENTS

Embodiments relate to systems and methods for providing intelligent embodied interactive agents with spatial understanding.

Embodiments may provide a system with an embodied agent (e.g., a virtual avatar, a 3D avatar, etc.) that can have an intelligent conversation with the user, backed by multiple APIs for fetching data and also capable of making API calls to alter data elsewhere. The conversational backend may include a large language model and text-to-speech and speech-to-text models. Moreover, the agents are capable of spatial understanding as they are integrated with vision-language understanding for understanding the scene. Hence, not only can the agent interact with digital computing APIs and fetch/edit data; it can also offer an understanding of the user's scene view from the headset and compute upon the input data. Embodiments may perform task inference based on the user's input command, and the scene along with the knowledge available to it.

In embodiments, the embodied agent has spatial scene awareness as perceived from the mounted cameras on the user's headset. Task inference may be based on spatial and auditory awareness and user commands.

Spatial and auditory awareness are part of the scene understanding process, using the mounted cameras images and feeding them into a visual language model or a multi-modal large language model. These models generally do an object recognition, segmentation and localization, as well as text recognition (if recognized any) to extract the necessary information from the user's surrounding environment. They also associate individual objects with their possible states (trained knowledge in the model) and identify the most possible event that is happening with these objects or human activities. With this level of spatial awareness, the user can ask for suggestions of how to deal with certain situations (e.g., find out where some objects are located, or search for more specific information about a given object). The large language capability behind the visual language model reasons about some suggestions for what the user asked (e.g., what should I do to better organize the room layout, how much to renovate this room). Such knowledge can either come from a training/fine-tuning databases (e.g., public database, the Internet, government documents, etc.), from Internet searches performed by the AI engine, etc.

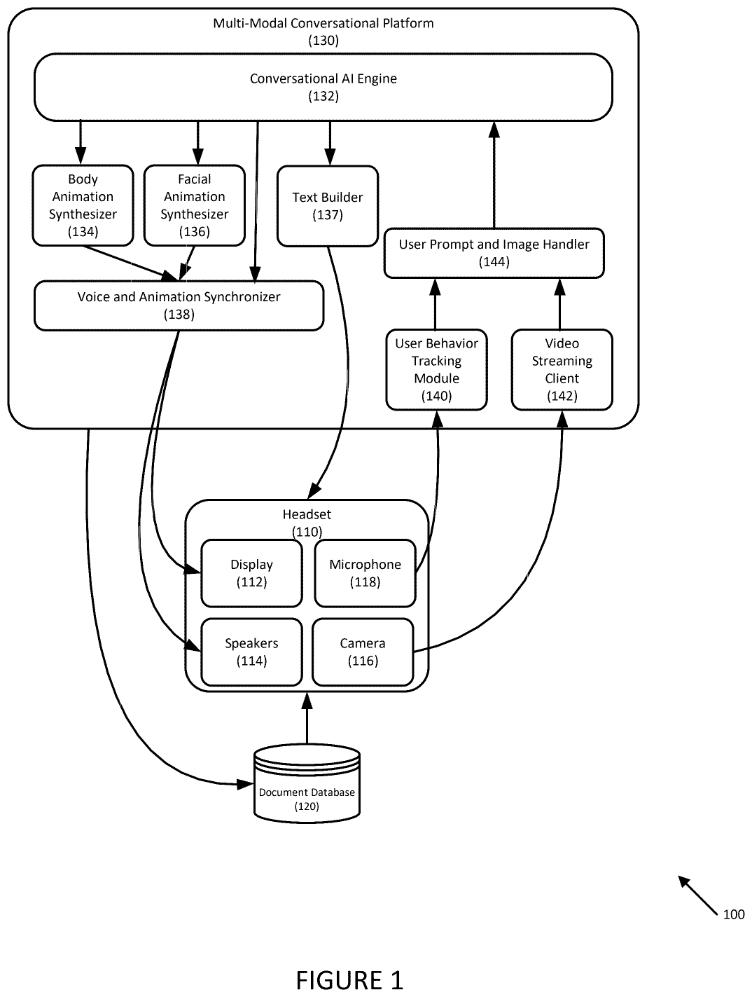

Referring to FIG. 1, a system for providing intelligent embodied interactive agents with spatial understanding is provided according to an embodiment. System 100 may include headset 110, which may be worn by a user. Headset 110 may include, for example, display 112, speakers or other audio output 114, microphone 118, and camera 116. Display 112 may display imagery for a user inside of headset 110, including an embodied agent, imagery from a virtual area, pass-through imagery from the surrounding area (e.g., augmented reality), documents, etc. Speakers 114 may output audio, such as sounds, text, etc.

Camera 116 may capture a view of what the user is seeing and may be mounted with a forward-looking orientation. This may include objects in the surrounding area, gestures made by the user's appendages, etc. Imagery from camera 116 may be provided to video streaming client 142 in multi-modal conversational platform 130.

Images from camera 116 may also be provided to user behavior tracking module 140.

Microphone 118 may capture audible utterances from the user, as well as ambient sounds in the surrounding area. Audio captured by microphone 118 may be provided to user behavior tracking module 140 in multi-modal conversational platform 130. User behavior tracking module 140 may also receive, for example, gestures, interaction history, user texts, user location information, images from camera 116, etc.

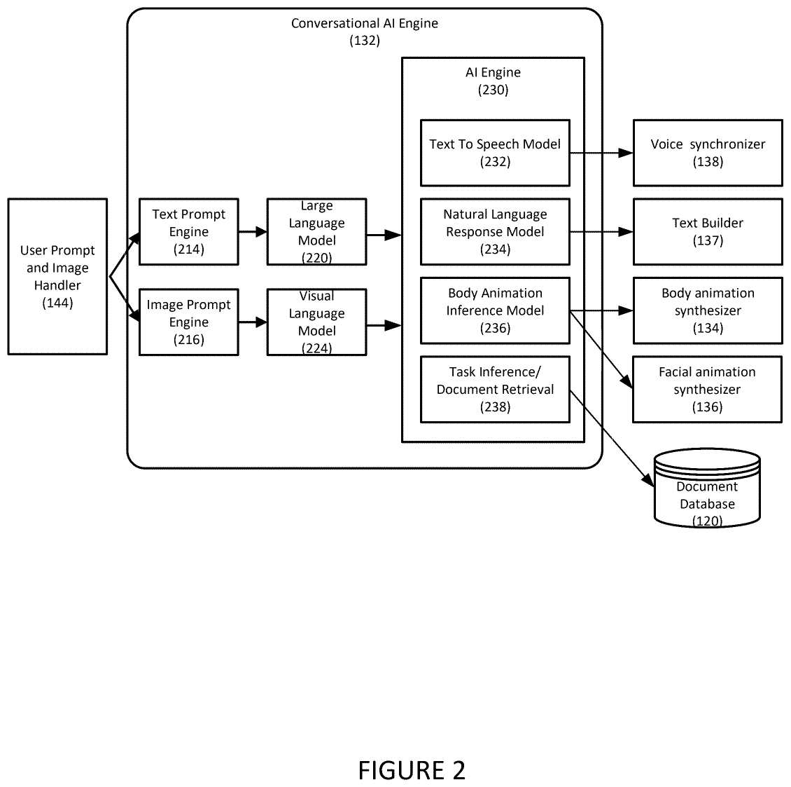

Multi-modal conversational platform 130 may be provided with conversational artificial intelligence (AI) engine 132. Conversational AI engine 132 may generate voice output, text output, and gesture output for an embodied agent, such as an avatar, a virtual person, etc. Conversational AI engine 132 may also identify documents or other data from document database 120 to provide to headset 110. Conversational AI engine 132 may have several architectures, which will be discussed below in conjunction with FIGS. 2, 3, and 4.

Conversational AI engine 132 may receive, as inputs, information on the user's situation, such as a context of the interaction with the user, the user's location (e.g., in a bank, at a merchant location, at home, etc.), etc. This information may be used as an input to a task inference algorithm to assist the language model in determining the information that is to be provided to the end user.

Conversational AI engine 132 may output gestures for the embodied agent to body animation synthesizer 134 and facial animation synthesizer 136. Body animation synthesizer 134 and facial animation synthesizer 136 may generate commands for animating the body and facial expressions for the embodied agent.

Voice and animation synchronizer 138 may receive the commands from body animation synthesizer 134 and facial animation synthesizer 136, as well as audio from conversational AI engine 132, so that the visual animation is synchronized with the audio. The output of voice and animation synchronizer 138 may be provided to headset 110, where the animation may be displayed on display 112, and the audio output by speakers 114.

Conversational AI engine 132 may output natural language responses to text builder 137, which may provide text output to headset 110 for display by display 112.

Multi-modal conversational platform 130 may also identify documents in document database 120 to be displayed on display 112.

User prompt and image handler 144 may receive the output of user behavior tracking module 140 and video streaming client 142 and may identify user prompts, questions, gestures, etc., as well as an identification of what the user is looking at. For example, user prompt and image handler 144 may determine whether the user is looking at the embodied agent, data being displayed on display 112, or something else.

FIG. 2 illustrates an exemplary architecture for a conversational AI engine according to an embodiment. Conversational AI engine 132 may receive the output of user prompt and image handler 144, which may include speech, text, and images.

Text prompt engine 214 may receive audio and/or text and may generate a text prompt, such as “What is the user asking for by this utterance: [text].” This may be provided to large language model 220, which may return a response to the prompt to AI engine 230.

In one embodiment, text prompt engine 214 may collect and build text entries from the user and may connect some preset questions with the input to prepare the final prompts that are sent to LLM 220 to generate appropriate responses.

For example, a prompt sentence may be “User input:”+“I want to know what my card balance is.”+“Instruction: construct your answer to this user input in json format, and put your answers in an order of, ‘response:’, ‘emotion:’, ‘gesture:’, ‘user task:’, ‘action call’) so that LLM 220 may output a query data structure that can be parsed and converted into corresponding avatar control function calls.

Image prompt engine 216 may receive streaming video from the camera on headset 110, and may generate an image prompt, such as “what is the user looking at” with the image or video. This prompt may be provided to visual language model 224, which may be similar to a large language model, but may interpret images or video instead of text.

The outputs of large language model 220 and visual language model 224 may be provided as inputs to AI engine 230. AI engine 230 may include text-to-speech model 232, which may convert text to speech for the audio response, natural language response model 234, which may be the response that is to be spoken by the avatar and may be sent to text builder 137 which may generate text for display as a subtitle, body animation inference model 236, which may infer what a proper avatar animation should be (e.g., sending the spoken sentence into a lip-sync animation generator which returns a query of facial animation blendshape weights, and a gesture cue (e.g., wave hand, stretch) to trigger the body animation on the avatar, etc.) and task inference/document retrieval 238, which may infer the task goal for the user. For example, user interaction history (e.g., a history of queries from the user and responses), environment object labels (e.g., labels for objects identified in the images or video, such as “chair,” “couch,” “car,” etc.), current user location information (e.g., in a furniture store, at a car dealership, etc.), user hand gestures, etc. may be used as a text prompt by text prompt engine 214, and LLM 220 may generate a corresponding estimation of what the user's task goal.

In one embodiment, the output of text-to-speech model 232 (e.g., a voice output) may be output to voice and animation synchronizer 138, the output of natural language response (e.g., text output) may be output to text builder 137, the output of body animation inference model 236 may be output to body animation synthesizer 134 and facial animation synthesizer 136, and the output of task inference/document retrieval 238 may be provided to retrieve a document from document database 120. The outputs of modules 120, 134, 136, 137, and 138 may then be provided to headset 110 as illustrated in FIG. 1.

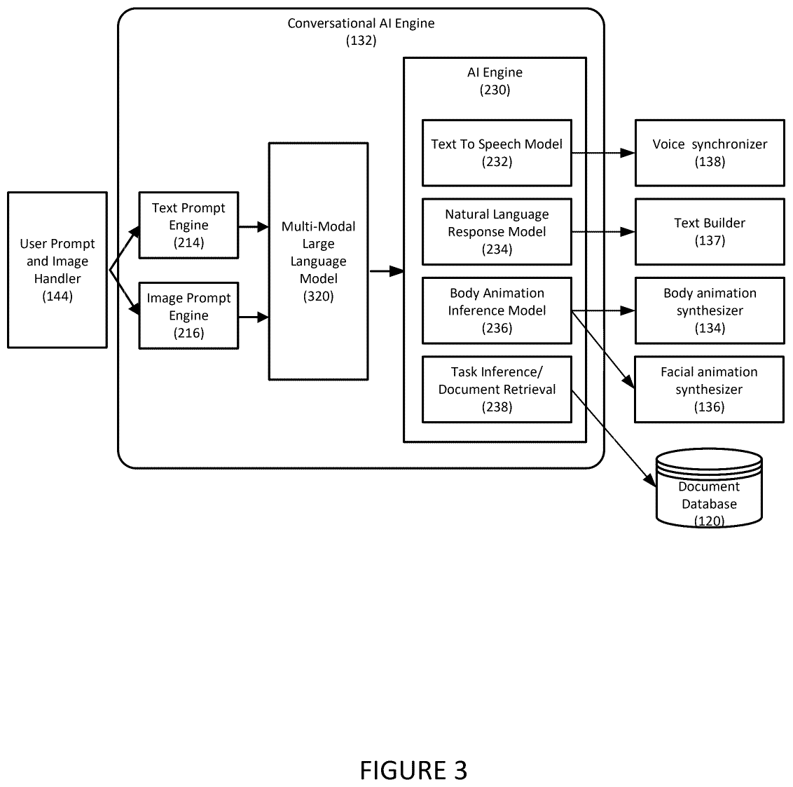

FIG. 3 illustrates an exemplary architecture for a conversational AI engine according to another embodiment. In FIG. 3, conversational AI engine 132 may receive the output of user prompt and image handler 144, which may include speech, text, and images.

Instead of large language model 220 and visual language model 224, a single model, multi-modal large language model 302 may be provided to respond to the prompts from text prompt engine 214 and image prompt engine 216. The output of multi-modal large language model 320 may be provided to AI engine 230 for processing as described with regard to FIG. 2.

In one embodiment, multi-modal large language model 302 may receive one or more prompts involving multiple modalities—such as a text modality and an image modality—and may output text responses with the additional capability of outputting gestures.

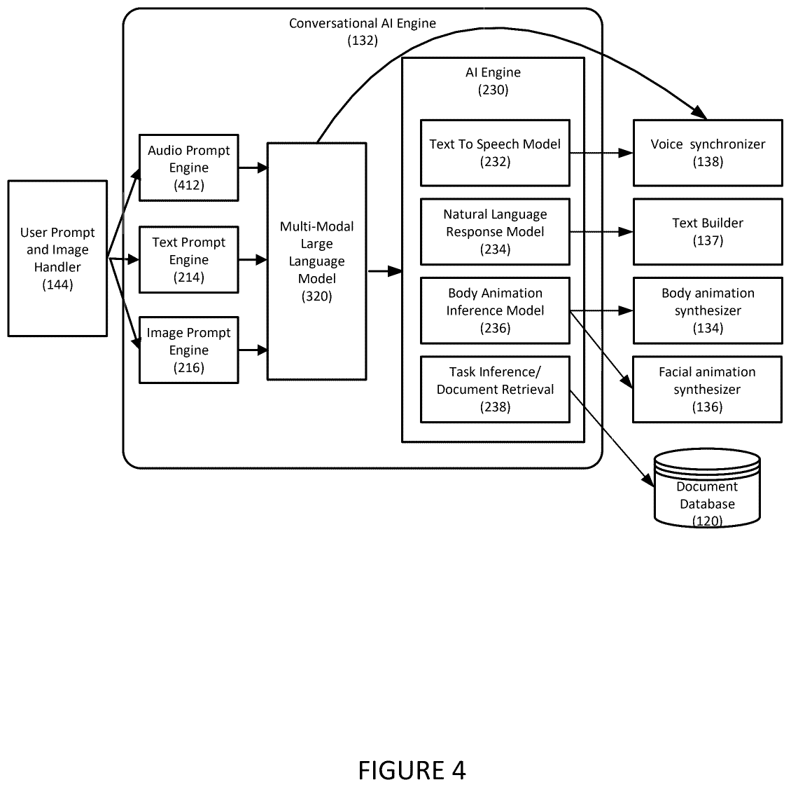

FIG. 4 illustrates an exemplary architecture for a conversational AI engine according to another embodiment. In FIG. 4, conversational AI engine 132 may receive the output of user prompt and image handler 144, which may include speech, text, and images, and may further provide an audio prompt to multi-modal large language model 320 using audio prompt engine 412.

In addition, multi-modal large language model 320 may output audio directly to voice synchronizer 138. In another embodiment, multi-modal large language model 320 may output audio directly to headset 110.

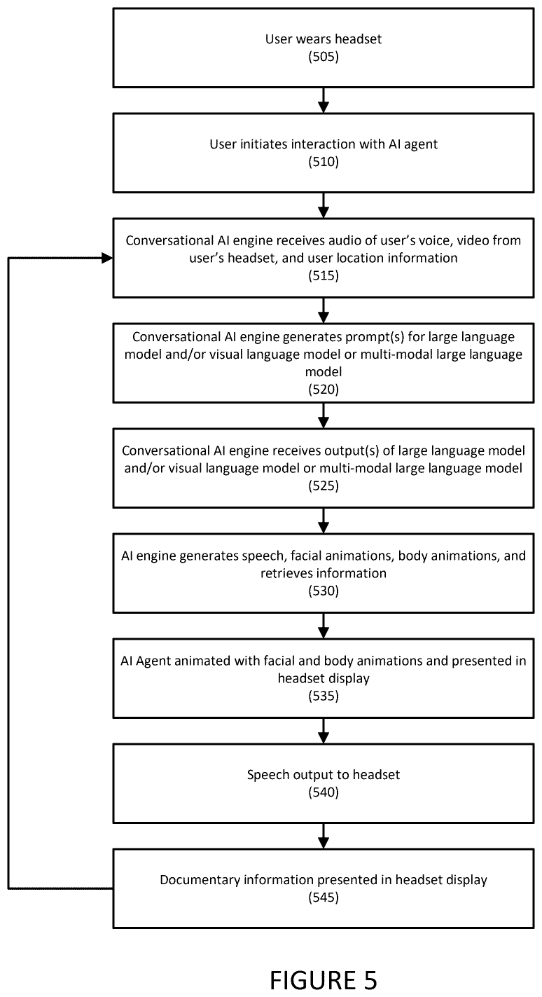

FIG. 5 illustrates a system for providing intelligent embodied interactive agents with spatial understanding according to an embodiment.

In step 505, a user may wear a headset. The headset may be a virtual reality headset, an augmented reality headset, etc. The headset may include a display to display a virtual reality or augmented reality view, one or more speakers to output audio, a microphone to capture the user's audio (e.g., speech), and one or more camera that may capture what the user is looking at.

The camera may also capture gestures made by the user, such as the user pointing or gesturing at something.

The headset or another connected device may identify a location of the user, such as in a store, at a bank, at home, etc.

In step 510, the user may initiate an interaction with an AI agent. For example, while in augmented reality mode, the user may look at a furniture set, and may ask the AI agent about the cost and financing for the furniture set.

In step 515, the conversational AI engine may receive the audio of user's query, video from user's headset, and the user location information. The video may include what the user is looking at (e.g., an object, such as a furniture set).

In step 520, the conversational AI engine may generate one or more prompts for a large language model and/or a visual language model, or a multi-modal large language model, based on the audio and video received from the headset, the location information, and any inferred task information. For example, the conversational AI engine may convert the audio from the user headset to text, and a text prompt engine may generate a prompt for a large language model or multi-modal language model using the text. An image prompt engine may generate a prompt for a visual language model, or a multi-modal language model based on the image(s) or video received from the user headset.

Additional information, such as user location information, inferred task information, etc. may also be provided to the large language model and/or the visual language model, or the multi-modal large language model.

In step 525, the conversational AI engine may receive output(s) from the large language model and/or the visual language model, or the multi-modal large language model in response to the queries. For example, the large language model and/or the visual language model, or the multi-modal large language model may return text for a voice output, a text output, a gesture output, and a document output.

In step 530, an AI engine may generate speech, facial animations, body animations, and retrieves information, such as documents, to present to the headset based on the output(s) of the large language model and/or the visual language model, or the multi-modal large language model.

For example, the AI engine may use a text to speech model to generate audio of a text output, a natural language response model to generate text in a natural language format to be displayed to the user (e.g., as a subtitle), a body animation inference model that may provide output to a body animation synthesizer and a facial animation synthesizer to generate animation for the AI agent, and a task inference/document retrieval model that may retrieve a document to present to the user from a document database.

In one embodiment, the animations and the speech of the AI agent may be synchronized using a voice and animation synchronizer.

In step 535, the AI agent may be animated with facial and body animations and the animation may be presented in the headset display.

In step 540, the audio of the text (i.e., speech) may be output to the speakers in the headset.

In step 545, the documentary information may be presented in headset display. For example, the conversational AI engine may retrieve documentary information using APIs and may present those on the display.

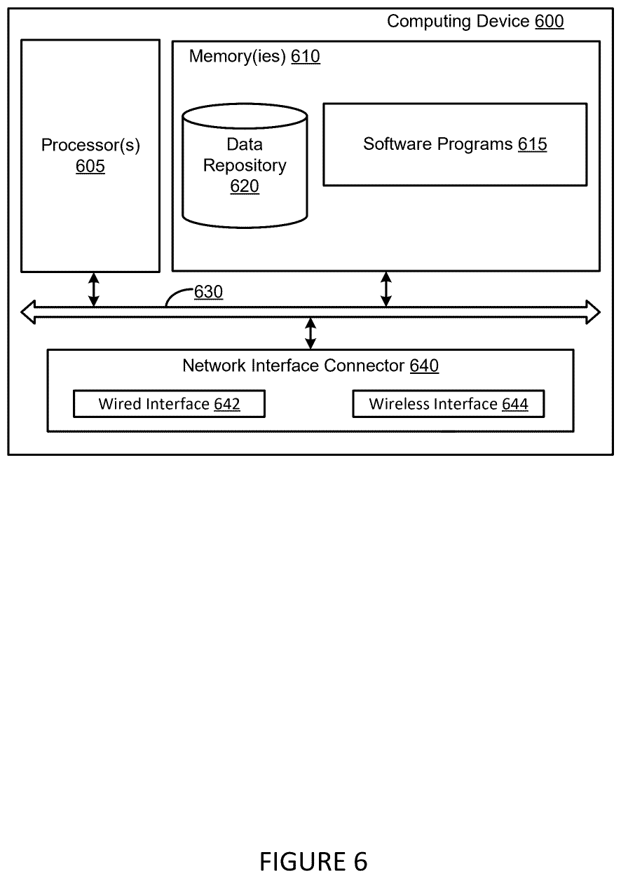

FIG. 6 depicts an exemplary computing system for implementing aspects of the present disclosure. FIG. 6 depicts exemplary computing device 600. Computing device 600 may represent the system components described herein. Computing device 600 may include processor 605 that may be coupled to memory 610. Memory 610 may include volatile memory. Processor 605 may execute computer-executable program code stored in memory 610, such as software programs 615. Software programs 615 may include one or more of the logical steps disclosed herein as a programmatic instruction, which may be executed by processor 605. Memory 610 may also include data repository 620, which may be nonvolatile memory for data persistence. Processor 605 and memory 610 may be coupled by bus 630. Bus 630 may also be coupled to one or more network interface connectors 640, such as wired network interface 642 or wireless network interface 644. Computing device 600 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a conversational artificial intelligence engine and from an augmented reality headset worn by a user, a query that is made to an embodied interactive agent that is displayed in a display of the augmented reality headset, wherein the query comprises audio of a user utterance and images or video captured by a camera of the augmented reality headset of what the user is seeing;
generating, by the conversational artificial intelligence engine, a prompt for a large language model based on the user utterance and the images or video;
providing, by the conversational artificial intelligence engine, the prompt to the large language model;
receiving, by the conversational artificial intelligence engine, an output of the large language model, wherein the output comprises text and gestures for the embodied interactive agent;
generating, by the conversational artificial intelligence engine, animations for the embodied interactive agent from the gestures and speech for the embodied interactive agent based on the text; and
outputting, by the conversational artificial intelligence engine, the animations and the speech to the augmented reality headset.

2. The method of claim 1, further comprising:
receiving, by the conversational artificial intelligence engine, user location information from the augmented reality headset, wherein the prompt is further based on the user location information.

3. The method of claim 1, further comprising:
inferring, by the conversational artificial intelligence engine, a task goal associated with the query, wherein the inference is based on a user interaction history, environment object labels, and user location information.

4. The method of claim 1, wherein the conversational artificial intelligence engine generates a text prompt for the large language model based on the user utterance and an image prompt for a visual language model, and the large language model and the visual language model return outputs.

5. The method of claim 1, wherein the large language model comprises a multi-modal large language model.

6. The method of claim 1, wherein the large language model further outputs an identification of a document to provide to the augmented reality headset.

7. The method of claim 1, wherein the display in the augmented reality headset displays the animations for the embodied interactive agent, and a speaker in the augmented reality headset outputs the speech for the embodied interactive agent.

8. A system, comprising:
an augmented reality headset comprising a camera, a microphone, a display, and a speaker, wherein the augmented reality headset is configured to be worn by a user; and
a multi-modal conversational platform comprising a conversational artificial intelligence engine that is configured to receive, from the augmented reality headset, a query that is made to an embodied interactive agent that is displayed by the display, wherein the query comprises audio of a user utterance and images or video captured by the camera of what the user is seeing; to generate a prompt for a large language model based on the user utterance and the images or video; to provide the prompt to the large language model, to receive an output of the large language model, wherein the output comprises text and gestures for the embodied interactive agent, to generate animations for the embodied interactive agent from the gestures and speech for the embodied interactive agent based on the text; and to output the animations and the speech to the augmented reality headset;
wherein the display of the augmented reality headset is configured to display the animations of the embodied interactive agent, and the speaker is configured to output the speech of the embodied interactive agent.

9. The system of claim 8, wherein the conversational artificial intelligence engine is further configured to receive user location information from the augmented reality headset, and the prompt is further based on the user location information.

10. The system of claim 8, wherein the conversational artificial intelligence engine is further configured to infer a task goal associated with the query, wherein the inference is based on a user interaction history, environment object labels, and user location information.

11. The system of claim 8, wherein the conversational artificial intelligence engine is further configured to generate a text prompt for the large language model based on the user utterance, and an image prompt for a visual language model, and the large language model and the visual language model return outputs.

12. The system of claim 8, wherein the large language model comprises a multi-modal large language model.

13. The system of claim 8, wherein the large language model further outputs an identification of a document to provide to the augmented reality headset.

14. A non-transitory computer readable storage medium, including instructions stored thereon, which when read and executed by one or more computer processors, cause the one or more computer processors to perform steps comprising:
receiving, from an augmented reality headset worn by a user, a query that is made to an embodied interactive agent that is displayed in a display of the augmented reality headset, wherein the query comprises audio of a user utterance and images or video captured by a camera of the augmented reality headset of what the user is seeing;
generating a prompt for a large language model based on the user utterance and the images or video;
providing the prompt to the large language model;
receiving an output of the large language model, wherein the output comprises text and gestures for the embodied interactive agent;
generating animations for the embodied interactive agent from the gestures and speech for the embodied interactive agent based on the text; and
outputting the animations and the speech to the augmented reality headset.

15. The non-transitory computer readable storage medium of claim 14, further comprising instructions stored thereon, which when read and executed by the one or more computer processors, cause the one or more computer processors to perform steps comprising: receiving user location information from the augmented reality headset, wherein the prompt is further based on the user location information.

16. The non-transitory computer readable storage medium of claim 14, further comprising instructions stored thereon, which when read and executed by the one or more computer processors, cause the one or more computer processors to perform steps comprising: inferring a task goal associated with the query, wherein the inference is based on a user interaction history, environment object labels, and user location information.

17. The non-transitory computer readable storage medium of claim 14, further comprising instructions stored thereon, which when read and executed by the one or more computer processors, cause the one or more computer processors to perform steps comprising: generating, a text prompt for the large language model based on the user utterance and an image prompt for a visual language model, and receiving outputs from the large language model and the visual language model.

18. The non-transitory computer readable storage medium of claim 14, wherein the large language model comprises a multi-modal large language model.

19. The non-transitory computer readable storage medium of claim 14, further comprising instructions stored thereon, which when read and executed by the one or more computer processors, cause the one or more computer processors to perform steps comprising: receiving from the large language model further, an identification of a document to provide to the augmented reality headset.

20. The non-transitory computer readable storage medium of claim 14, wherein the display in the augmented reality headset displays the animations for the embodied interactive agent, and a speaker in the augmented reality headset outputs the speech for the embodied interactive agent.
